(19) United States
(12) Patent Application Publication
(10) Pub. No.: US 2025/0213071 A1
(43) Pub. Date: Jul. 3, 2025

(54) Multi-Purpose Kitchen Appliance with Vacuuming Device, Adapter Unit and Method

(71) Applicant: NOVUM GROUP AG, Bäch (CH)

(72) Inventor: Dejan Bekic, Bennau (CH)

(21) Appl. No.: 18/866,824

(22) PCT Filed: May 16, 2023
(86) PCT No.: PCT/EP2023/063079

§ 371 Date: Nov. 18, 2024

(30) Foreign Application Priority Data
May 19, 2022 (DE) 10 2022 112 672

(51) Int. Cl. A47J 43/046

(52) U.S. Cl. CPC A47J 43/046

(57) ABSTRACT

The invention relates to a multi-purpose kitchen appliance (1), more particularly a food processor with a base apparatus (3) and a preparation vessel (2) that can be connected to the base apparatus, wherein the preparation vessel (2) has at least one pot (4) and a lid (5) that closes a pot opening of the pot (4), wherein a vacuuming device (6), which is integrated in the base apparatus (3) or connected to the base apparatus (3), has at least one evacuation unit (7) and a connection element (8), wherein a first through-hole (9) is formed in the pot (4) or in the lid (5), and the connection element (8) is designed to fluidically connect the evacuation unit (7) to the through-hole (9) in order to evacuate the pot (4). The invention also relates to an adapter unit and to a method.

### FIELD OF THE INVENTION

The present invention relates to a multipurpose kitchen appliance with a vacuuming device and a method.

### PRIOR ART

Multipurpose kitchen appliances are known. For example, the documents DE 10 2014 112 959 A1 and DE 10 2014 113 552 A1 disclose multipurpose kitchen appliances designed as combined cooking and blending devices.

For example, multipurpose kitchen appliances have a removable pot in which, for example, a mixer for preparing food is arranged. The mixer can be driven by an electric motor on the kitchen appliance side, for which the receiving area and the pot have corresponding coupling elements. Furthermore, it is known to provide heating means for the pot. For this purpose, the bottom of the pot has, for example, an electrically controllable heating element. In addition, the pot can also be provided with electrical measuring equipment to measure temperature, pressure or similar.

Furthermore, methods for operating kitchen appliances are known from the prior art. For example, a method is known from DE 10 2016 110 715 A1, in particular a method for operating a food processor, wherein at least one processing device of the food processor is controlled for the at least partially automatic preparation of at least one food item in a preparation operation. The method comprises the following steps:
Determining at least one control value by initially acquiring at least one control parameter during the preparation process, the control parameter being specific to the preparation,
Determining at least one result value by a second acquisition of at least one result parameter, wherein the result parameter is specific for the result of the preparation,
Recording the control value and the result value in a preparation record so that they are assigned to the preparation as a recorded preparation.

### Problem Addressed and Solution of the Invention

The object of the present invention is to provide an alternative multipurpose kitchen appliance. Furthermore, it is an object of the invention to provide an adapter unit for a pot lid. Finally, it is the object of the invention to provide a method for operating a multipurpose kitchen appliance.

The objects are each solved by the features of the independent claims 1, 17 and 19. Preferred embodiments are set out in the dependent claims.

According to a first aspect of the invention, a multipurpose kitchen appliance is provided, in particular a food processor having a base unit and a preparation vessel connectable to the base unit, the preparation vessel having at least one pot and a lid for closing a pot opening of the pot. Furthermore, a vacuum device is provided, which is integrated into the base unit or connected to the base unit. The vacuuming equipment has at least one evacuating unit and a connecting element, wherein a first breakthrough is formed in the pot or in the lid, and the connecting element is set up to fluidically connect the evacuating unit to the breakthrough for evacuating the pot. The connecting element can be designed as a vacuum hose, for example.

The evacuation equipment is preferably suited and provided for pumping a fluid, and in particular a gas, and especially preferably air, out of the pot. For this purpose, the evacuation equipment can be designed, for example, as a vacuum pump or other suitable compression equipment. The evacuation equipment can also be provided separately. In this case, the evacuation equipment can be fluidically connected to the pot, for example via the connecting element, in order to evacuate the pot or to pump out a fluid present in the pot.

The fluidic connection with the pot can be realized, for example, via an opening in the lid or an opening on the side wall of the pot. It is preferable for the first breakthrough to be formed by an opening in the lid.

The invention therefore provides a multi-purpose kitchen appliance that is equipped with vacuuming equipment. This means that a vacuum can be applied to the pot before preparing food. In this way, oxidation processes in the processed food can be reduced and thus damage to healthy enzymes and unwanted discoloration of the food can be prevented or at least reduced. This measure also enables vacuum cooking or sous-vide cooking of meat, fish or vegetables at relatively low temperatures of less than 100° C. and therefore gentle preparation. An otherwise mandatory plastic bag enclosing the food is no longer necessary.

In particular, the multi-purpose kitchen appliance is provided with a heating element for heating the food in the pot, so that it is possible to boil, steam, cook, etc. food under vacuum by using the heating element.

The multi-purpose kitchen appliance 1 can in particular have a sensor device, wherein the sensor device is provided to sense pressure data in relation to a location of the pot. The control unit can be set up to operate the vacuuming equipment based on the pressure data. The control unit can be set up to determine an initial pressure based on the pressure data and to operate the vacuuming equipment to adjust the pressure to a setpoint.

In one embodiment of the invention, the breakthrough is formed by an opening in the lid and an adapter unit is inserted in the opening of the lid, wherein the adapter unit is set up to be connected to the connecting element. The adapter unit can be a plug, for example, which can be connected to the connecting element on the one hand and placed on the adapter on the other.

The adapter unit may in particular comprise:
a base body, preferably of rotationally symmetrical design, which is inserted by a lower open end into the first breakthrough formed by the lid opening of the lid;
a first termination element that terminates the base body at the upper axial end and on whose upper side a receiving section for receiving the connecting element is formed;
   wherein the first termination element in the receiving portion has a second breakthrough and an elastic element arranged in the second breakthrough, which is set up to seal the second breakthrough in an at least first state of use and to open the second breakthrough in an at least second state of use.

It is preferable for the elastic element to be a rubber seal designed as a one-way valve. The rubber seal can be inserted in the second breakthrough in particular. When the rubber seal is enclosed by the connecting element, for example, and a vacuum is applied to the rubber seal, the rubber seal opens the second breakthrough so that the pot can be evacuated. When the evacuation is finished, for example, the rubber seal closes and maintains the vacuum in the pot. To let air into the pot, force can be applied to the rubber seal, for example by a user pressing it down with a finger, to open the breakthrough and create a pressure equalization.

The adapter unit may in particular have a projection on a circumferential section that extends radially outwards and is arranged in the circumferential direction, which forms an axially downward-facing contact surface that is set up to be brought into contact with a corresponding contact surface of the cover.

In particular, the receiving section can have an axially upwardly extending and circumferentially extending projection that forms a radial boundary of the receiving section.

It is advantageous if a first sealing means is arranged and designed to seal the adapter unit with respect to the first breakthrough of the lid. This may be, for example, a rubberized coating arranged around the circumference below the projection, which can be brought into contact with a section of the lid that extends axially downwards.

In a further embodiment of the invention, the adapter unit further comprises a connecting part. The connecting part is in particular rotationally symmetrical and has a second upper termination element with a third breakthrough, wherein the third opening is connectable to the connecting part via a connection piece. A connecting piece that can be connected or is connected to the connecting element makes it easier to connect the connecting element to the first breakthrough, in particular to the opening in the lid. The connecting part can be designed as a plug, for example. The connecting part can be designed integrally with the connecting element. In an alternative embodiment, the connecting element and the connecting part can be designed as separate components, in particular in two parts.

It is preferred that the connecting part has a second sealing means that can be brought into contact with the receiving section and encloses the elastic element in the circumferential direction. When the connecting part is placed on the receiving section, it encloses the elastic element and connects the second breakthrough fluidically to an intake opening of the connecting element during an evacuation. In other words, during operation of the evacuation unit, the connecting part is pressed tightly against the top of the adapter unit and the elastic element releases the second breakthrough. Once evacuation is complete, the connecting part can be removed while the elastic element of the adapter unit maintains the vacuum in the pot.

In this way, a connecting part can be advantageously provided that does not require a mechanical lock for evacuation. The sealing connection between the adapter unit and the connecting part is achieved by means of negative pressure. In this way, the connecting element can furthermore be deployed quickly.

In one embodiment of the invention, it is provided that the lid closes the pot, and the connecting part connected to the connecting element is inserted into the receiving section such that the second sealing means contacts the top of the first termination element, so that during evacuation of the pot by means of the evacuation unit, the sealing means of the connecting part is sucked or pressed into the receiving section, whereby the connecting part closes tightly; and

the elastic element opens the breakthrough, so that a flow channel is formed which fluidically connects the space of the pot with the connecting element, so that a fluid present in the pot can be pumped out, and that at the completion of evacuation, the elastic element seals the second breakthrough to maintain the vacuum in the pot and releases the connecting part for removal from the receiving section.

According to a second aspect of the invention, an adapter unit for a lid of a multi-purpose kitchen appliance is provided, the adapter unit comprising:
a base body, in particular of rotationally symmetrical design, which can be inserted with a lower open end into a first breakthrough of a lid of a pot,
a termination element that terminates the base body at the upper axial end and on whose upper side a receiving section for receiving a connecting element is formed;
wherein the termination element in the receiving portion has a second breakthrough and an elastic element arranged in the second breakthrough, which is set up to seal the breakthrough in an at least first state of use and to open the breakthrough in an at least second state of use.

The adapter unit according to the second aspect of the invention can be further formed with the features of the adapter unit of the multi-purpose kitchen appliance according to the first aspect.

To avoid repetition, reference is made to the above explanations.

According to a third aspect of the invention, a method is provided, namely a method of operating a multi-purpose kitchen appliance comprising a preparation vessel having a pot and a lid, a base unit and vacuuming equipment set up to evacuate the pot, wherein the method comprises:
Acquiring pressure data in relation to a position in the pot,
Operating the vacuuming equipment to evacuate a fluid from the pot depending on the pressure data in the pot.
   The method is intended in particular to operate a food processor. Thus, a method is preferably provided for operating a food processor with vacuuming equipment to enable the preparation of food under vacuum conditions. Pressure sensors in particular can be used to acquire pressure data.

### LIST OF FIGURES

Exemplary embodiments of the invention are explained below with reference to the attached schematic drawings.

The drawings show in:

FIG. 1 a multi-purpose kitchen appliance in a preferred embodiment in a schematic view;

FIG. 2 the multi-purpose kitchen appliance of FIG. 1 in a further preferred embodiment in section;

FIG. 3 the multi-purpose kitchen appliance from FIG. 1 in further views and sections;

FIG. 4 a lid of the pot of the multi-purpose kitchen appliance of FIGS. 1, 2 and 3 in several views;

FIG. 5 an adapter in a preferred embodiment for the lid of FIG. 5 in several views;

FIG. 6 a connecting part in a preferred embodiment;

FIG. 7 a vessel lid for use with a vacuum hose;

FIG. 8 a vessel for use with the vessel lid from FIG. 8:

FIG. 9 Method of operation.

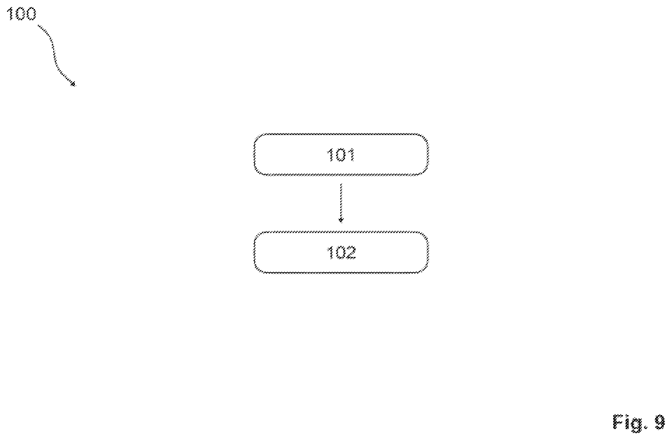

The design and function of the multi-purpose kitchen appliance and the adapter unit are explained below with reference to the figures. The figures show preferred embodiments of the invention.

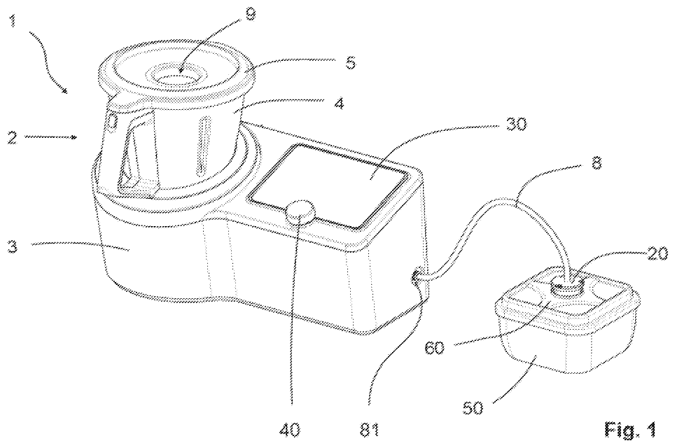

FIG. 1 shows an exemplary multi-purpose kitchen appliance 1 in the form of a food processor that can be driven by an electric motor. The food processor 1 comprises the components preparation vessel 2, base unit 3, pot 4 and lid 5 with an opening 9.

The food processor 1 also has a mixer or blade for preparing food. The blade is connected drive-actively to a drive unit via a coupling element. The food processor 1 may also be provided with a heating element. In addition, sensors can be provided, which are each arranged, for example, in different areas of the food processor 1, inside or outside the food processor 1, for acquisition of different acquisition variables.

In addition, the food processor 1 may comprise a control panel 30 comprising, for example, a display, preferably a touch screen. In particular, the control panel 30 serves as an input device. In particular, the display serves as both an input and an output means. In particular, the control panel enables a user of the food processor 1 to set and/or activate and/or deactivate preparation parameters and/or recipes and/or operating parameters, such as the mixer speed, the heating temperature and/or the duration of preparation or mixing and/or various programs of the food processor. The display can also be used to output recipe-related instructions and/or hints and/or graphic operating elements.

The food processor I has a switch 40, which is provided in particular for switching the food processor on and off. However, switch 70 can also be used to confirm input commands or similar.

In accordance with the invention, the food processor shown in FIG. 1 is provided with vacuuming equipment with which, on the one hand, the pot 5 can be evacuated in order to prepare food in an evacuated state and, on the other hand, to evacuate external vessels, such as the vessel 50 shown, for example, in order to preserve prepared food for longer.

A sensing device is arranged in the base unit 3 and is set up to sense pressure data in relation to a position of the pot 4 and to operate the vacuuming equipment 6 on the basis of the pressure data. The control unit can determine an initial pressure based on the pressure data and operate the vacuuming equipment to adjust the pressure to a setpoint.

Pressure measurements can preferably be processed into control-relevant data at different points at different times during the evacuation process. This allows precise statements to be made about the current status of the system.

It is preferable to select from a plurality of vacuum levels. The vacuum level is to be understood here as a measure of the negative pressure. It has proven to be advantageous if three or four different vacuum levels can be selected. For example, in one embodiment, the following vacuum modes can be selected: 0 bar, 0.3 bar and 0.7 bar. In another embodiment, the following vacuum modes can be selected: 0 bar, 0.25 bar, 0.5 bar and 0.75 bar.

The vacuuming equipment 6 can be operated via the control panel 30, which for example comprises a display, preferably a touch screen. In particular, the control panel allows a user to set a specific vacuum level.

Providing different vacuum conditions has the advantage of being able to react flexibly to preparation requirements with regard to the food or the type of preparation. It is therefore conceivable that an absolute vacuum is not desirable for every food and every cooking temperature.

The vacuuming equipment 6 is integrated into the base unit 3 and has at least one evacuation unit 7 in the form of a vacuum pump and a connecting element 20. The connecting element is preferably a vacuum hose 8. The vacuum hose 8 is connected to a connection 81 on the device side, which in turn fluidically connects the end of the vacuum hose 8 connected to it to the vacuum pump. The other end of the vacuum hose 8 is provided with a connecting part 20, which is placed in a receiving area of a vessel 50. The receiving area of the vessel 50 has an opening in which a rubber element is inserted, which functions as a one-way valve. In this way, the fluid, in particular air, can be sucked out of the vessel 50 while the one-way valve simultaneously maintains the vacuum in the vessel.

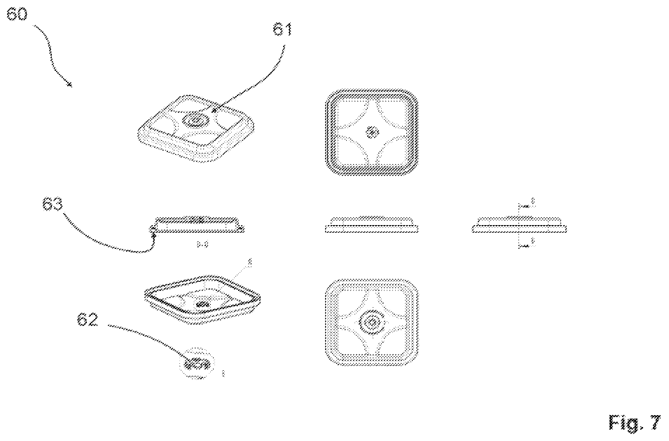

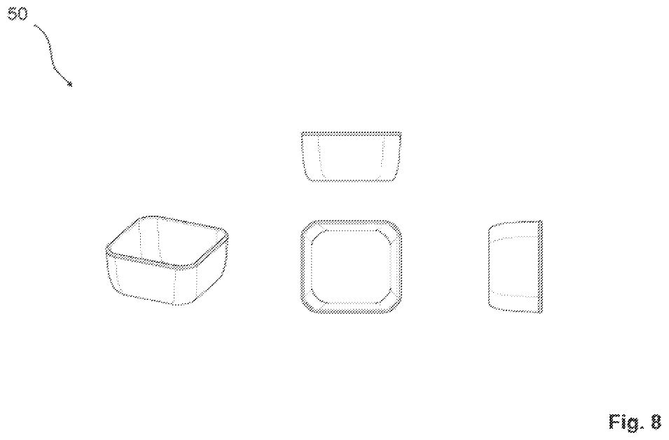

Additional details on the vessel and vessel lid can be found in FIGS. 7 and 8.

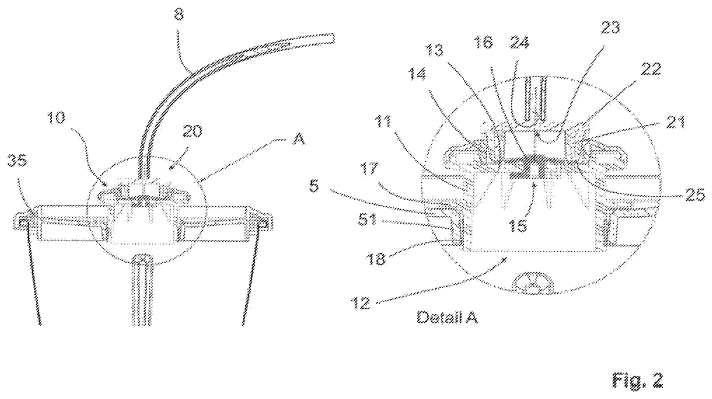

FIG. 2 shows how the vacuum hose 8 fluidically connects the vacuum pump with the opening 9 of the lid 5. Detailed view A shows an enlarged section of the connection of lid 5, adapter unit 10 and connecting part 20.

To improve the connection of the vacuum hose 8, an adapter unit 10 is initially provided, which is inserted into the opening 9 of the lid 5.

The adapter unit comprises a rotationally symmetrical base body 11, which is inserted into the opening 9 with a lower open end 12. Furthermore, the adapter unit comprises a termination element 13, which terminates the base body 11 at the upper axial end and on the upper side of which a receiving section 14 is formed for receiving a vacuum hose 8.

The termination element 13 has a second breakthrough 15 in the receiving section 14 and an elastic element 16 arranged in the second breakthrough 15, which is set up to seal the breakthrough 15 in at least a first state of use and to open the breakthrough 15 in at least a second state of use.

The elastic element 16 is a rubber seal which is inserted into the hole-shaped breakthrough and is designed as a one-way valve. When a vacuum is applied, the rubber seal 16 releases the opening 15 so that the air can be evacuated and maintains the vacuum in the pot when evacuation is complete. By manually pressing in the center of the rubber seal 16, the opening 15 is opened and pressure equalization can take place.

The adapter unit 10 further has a projection 17 on a circumferential section that extends radially outwards and is arranged in the circumferential direction, which forms an axially downward-facing contact surface that is set up to be brought into contact with a corresponding contact surface of the lid 5. This prevents the adapter unit 10 from falling into the pot.

The receiving section 14 has an axially upwardly extending and circumferentially extending projection that forms a radial boundary of the receiving section 14. Furthermore, a rubber coating 18 is arranged and designed to seal the adapter unit 10 with respect to the first breakthrough 9 of the lid. This lies against an insertion section of lid 5.

For better coupling of the other vacuum hose end to the adapter unit 10, the other vacuum hose end is connected to a connecting part 20, which can be inserted into the adapter unit 10.

The connecting part 20 is rotationally symmetrical 21 corresponding to the adapter unit 10 and has an upper second termination element 22 with a third breakthrough 23, wherein the third breakthrough 23 is fluidically connected to the vacuum hose 8 via a tubular connection piece 24. The breakthrough 23 has a funnel-shaped profile in cross-section and effectively forms the suction opening of the vacuum hose 8.

The connecting part 20 has a sealing means 25 which is in contact with the receiving section 14 and encloses the elastic element 16 in the circumferential direction. The sealing means is preferably rubber-like and arranged at least at one axial end of the connecting part 20, so that it comes into contact with the top of the adapter unit and surrounds the elastic element 16.

About the functionality:
The pot is inserted into the receiving area of the base unit and closed with the lid, wherein the lid is preferably locked by means of locking equipment. The lid 5 seals the pot 4 with a circumferential seal 35.
The adapter unit 10 is inserted into the opening 9 of the lid 5. The connecting part 20, in turn, is inserted into or placed on the receiving section of the adapter unit.
When the vacuum pump is switched on, the rubber-coated section 25 is pressed firmly into the acceptance section by the resulting vacuum, so that the connecting part 20 sits tightly on the termination element 13 of the adapter unit 10.
The negative pressure causes the elastic element 16 to open the breakthrough 15, so that a flow channel is formed which fluidically connects the space of the pot 4 with the vacuum hose 8, so that a fluid, in particular air, in the pot 4 can be pumped out.
When evacuation is complete, the elastic element 16 keeps the second breakthrough 15 sealed to maintain the vacuum in the pot 4. Once evacuation is complete, the connecting part 20 is released and can be removed.

The food processor 1 can now be operated to prepare food under vacuum or under a vacuum level. After the food has been prepared, the pressure can be equalized, i.e., the pot can be ventilated by pressing the elastic element.

The adapter unit described in FIG. 2 can also be used analogously for the vessel 50. The functionality for evacuating the fluid is the same.

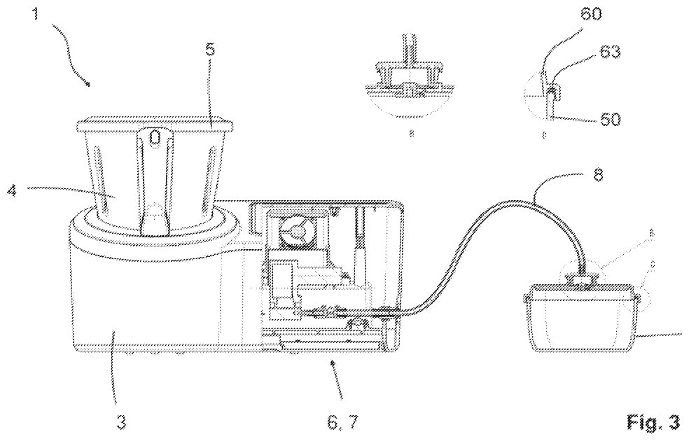

FIG. 3 shows the food processor 1 of FIG. 1 in a sectional view and other views. In particular, it is shown how the vacuuming equipment 6 and the evacuation unit 7 are integrated into the base unit.

Detailed view B shows an enlarged section of the connection of vessel lid 60, adapter unit for the vessel lid and connecting part 20. The adapter unit 10 can be integrated into the vessel lid and have the same features as the adapter unit 10 described above, so that reference can be made to the design in FIG. 2.

Detailed view C shows an enlarged section of a sealing area between vessel 50 and vessel lid 60. The vessel lid 60 is sealed with respect to the vessel 50 with a circumferential sealing ring, which is routed in a circumferential groove in a lid section.

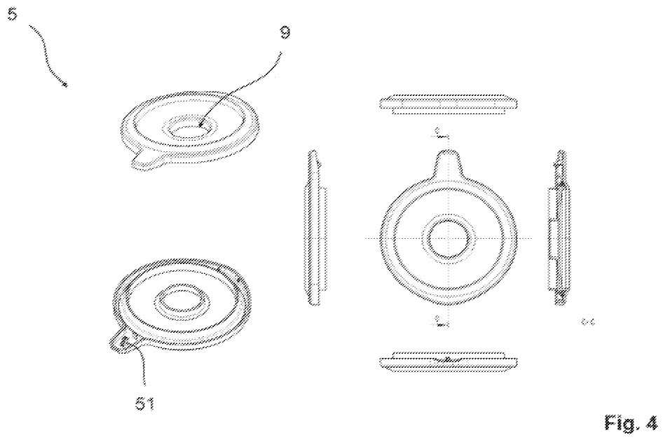

FIG. 4 shows further views of the lid 5. A collar-shaped catch is provided on the underside of a lid handle, which corresponds, for example, to a locking device integrated in the handle.

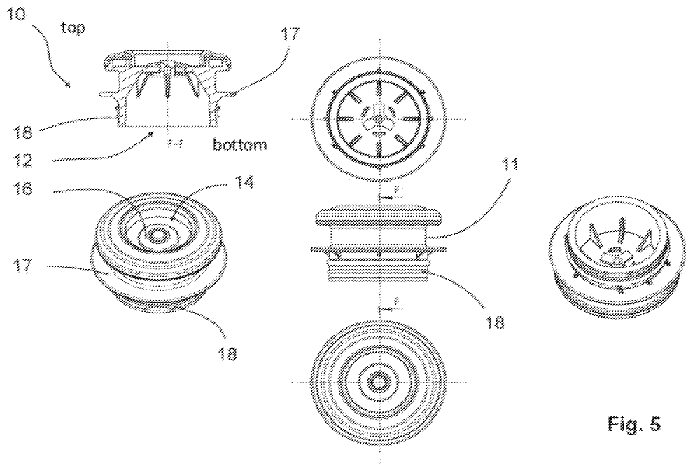

FIG. 5 shows the adapter unit 10 of FIG. 2 in a sectional view and other views. Reference can also be made in particular to the explanations in FIG. 2.

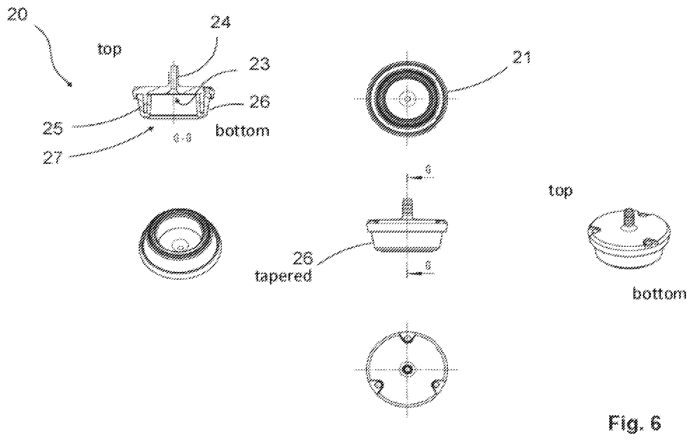

FIG. 6 shows the connecting parts from FIGS. 1, 2 and 3 in a sectional view and other views. The tapered section 26 is particularly easy to recognize. The tapered section 26 facilitates insertion into the adapter unit 10 and enlarges the adjacent outer surface in order to increase the sealing effect. The connecting part 20 is preferably designed as a plug, the outer surface of which is rubberized, preferably on the inside and outside. Reference can also be made in particular to the explanations in FIG. 2.

FIGS. 7 and 8 show further views of the vessel 50 and the vessel lid 60. Also shown in FIG. 7 is an elastic element 62, which has the same function as the elastic element 16. Reference can also be made to the explanations in FIGS. 1 and 3.

FIG. 13 schematically shows a method 100 for operating the multi-purpose kitchen appliance 1 of FIG. 1. The method comprises the following steps:
Acquiring 101 pressure data in relation to a position in the pot 4; and
Operating 102 the vacuuming equipment to evacuate a fluid from the pot 4 depending on the pressure data in pot 4.

Further embodiments of the invention will become apparent to those skilled in the art within the scope of the following claims and the attached drawings.

1. A multi-purpose food processor, in particular a food processor having a base unit and a preparation vessel which can be connected to the base unit, wherein the preparation vessel has at least one pot and a lid which closes an opening of the pot, wherein a vacuuming equipment integrated in the base unit or connected to the base unit has at least one evacuation unit and a connecting element, wherein a first breakthrough is formed in the pot or in the lid, and the connecting element is set up to fluidically connect the evacuation unit to the breakthrough for evacuating the pot.

2. The multi-purpose kitchen appliance according to claim 1, wherein the connecting element is designed as a vacuum hose.

3. The multi-purpose kitchen appliance according to claim 1, wherein a sensing device is arranged and set up to sense pressure data with respect to a location of the pot.

4. The multi-purpose kitchen appliance according to claim 1, wherein the control unit is set up to operate the vacuuming equipment on the basis of the pressure data.

5. The multi-purpose kitchen appliance according to claim 3, wherein the control unit is set up to determine an output pressure based on the pressure data; and to operate the vacuuming equipment to adjust the pressure to a setpoint.

6. The multi-purpose kitchen appliance according to claim 1, wherein the breakthrough is formed by an opening in the lid and an adapter unit is inserted in the opening of the lid, wherein the adapter unit is set up to be connected to the connecting element.

7. The multi-purpose kitchen appliance according to claim 6, the adapter unit comprising:
a base body which is inserted with a lower open end into the first breakthrough formed by the lid opening of the lid,
a first termination element that terminates the base body at the upper axial end and on whose upper side a receiving section for receiving the connecting element is formed;
wherein the first termination element has a second breakthrough in the receiving section and an elastic element arranged in the second breakthrough, which is set up to seal the second breakthrough in at least a first state of use and to open the second breakthrough in at least a second state of use.

8. The multi-purpose kitchen appliance according to claim 5, wherein the elastic element is a rubber seal which is designed as a one-way valve which preferably allows a ventilation process by manual application of a force by a user.

9. The multi-purpose kitchen appliance according to claim 7, the adapter unit having a projection which extends radially outwards at a circumferential section and is arranged in the circumferential direction and which forms an axially downwardly directed contact surface which is set up to be brought into contact with a corresponding contact surface of the lid.

10. The multi-purpose kitchen appliance according to claim 7, wherein the receiving portion comprises an axially upwardly extending and circumferentially circumferential projection forming a radial boundary of the receiving portion.

11. The multi-purpose kitchen appliance according to claim 7, wherein a first sealing means is arranged and configured to seal the adapter unit with respect to the first breakthrough of the lid.

12. The multi-purpose kitchen appliance according to claim 7, wherein the adapter unit further comprises a connecting part, wherein the connecting part is in particular rotationally symmetrical and has an upper second termination element with a third breakthrough, wherein the third breakthrough can be connected to the connecting element via a connecting piece.

13. The multi-purpose kitchen appliance according to claim 12, wherein the connecting part comprises a second sealing means which can be brought into contact with the receiving portion and encloses the elastic element in the circumferential direction.

14. The multi-purpose kitchen appliance according to claim 13, wherein the lid closes the pot and the connecting part connected to the connecting element is inserted into the receiving portion, such that the second sealing means contacts the upper side of the first termination element, so that during evacuation of the pot y means of the evacuation unit,
the sealing means of the connecting part is sucked or pressed into the receiving section, whereby the connecting part closes tightly, and
the elastic element opens the breakthrough, so that a flow channel is formed which fluidically connects the space of the pot with the connecting element, so that a fluid present in the pot can be pumped out.

15. The multi-purpose kitchen appliance according to claim 14, wherein when evacuation is complete, the elastic element seals the second breakthrough to maintain the vacuum in the pot.

16. The multi-purpose kitchen appliance according to claim 4, wherein the termination of the evacuation releases the connecting part for removal from the receiving section.

17. An adapter unit for a lid of a multi-purpose kitchen appliance, comprising:
a base body which can be inserted with a lower open end into a first breakthrough of a lid of a pot,
a termination element that terminates the base body at the upper axial end and on whose upper side a receiving section for receiving a connecting element is formed;
wherein the termination element has a second breakthrough in the receiving section and an elastic element arranged in the second breakthrough, which is set up to seal the breakthrough in at least a first state of use and to open the breakthrough in at least a second state of use.

18. The adapter unit according to claim 17, wherein the adapter unit is further formed with at least one of the features of claim 8.

19. A method of operating a multi-purpose kitchen appliance comprising a preparation vessel having a pot and a lid, a base unit and vacuuming equipment set up to evacuate the pot, wherein the method comprises:
Acquiring pressure data in relation to a position in the pot,
Operating the vacuuming equipment to evacuate a fluid from the pot depending on the pressure data in pot.
